(19) United States
(12) Patent Application Publication
(10) Pub. No.: US 2016/0349059 A1
(43) Pub. Date: Dec. 1, 2016

(54) Method And System For Real-Time Sensory-Based Navigation

(71) Applicant: Walc Inc., New York, NY (US)

(72) Inventors: Allison McGuire, New York, NY (US); Daniel Herrington, New York, NY (US)

(21) Appl. No.: 14/820,407

(22) Filed: Aug. 6, 2015

Related U.S. Application Data
(60) Provisional application No. 62/033,951, filed on Aug. 6, 2014.

(51) Int. Cl. G01C 21/20; G01C 21/34; H04W 4/02

(52) U.S. Cl. CPC G01C 21/20; H04W 4/02; G01C 21/3407; G01C 21/3476

(57) ABSTRACT

Systems and methods according to which a mobile application is running on a user's mobile device sends and receives data from a landmark navigation server. The landmark navigation server is coupled to a database that stores landmarks located along a user's route. Additionally, the database can store various data about landmarks, e.g., in connection with a landmark being visible on a street. When a user launches a mobile application, the mobile application prompts the user to enter a starting location and an ending location. Information regarding the starting location and the ending location is sent to the landmark navigation server, which responds, with route information to the mobile application. Via the graphical user interface on the mobile application, the user is then presented with route information, the route information including a heading direction and an orientation with respect to one or more landmarks located along the user's route.

### CROSS-REFERENCE TO RELATED APPLICATION

The present application claims priority to and benefit from U.S. Provisional Patent Application No. 62/033,951, filed on Aug. 6, 2014, and titled “Method And System For Collaboratively Tracking And Reporting Potentially Unsafe And/Or Unsavory Disturbances Along Pedestrian Pathways To Create Real-Time, Relevant Navigations,” the entire content of which is herein expressly incorporated by reference.

### TECHNICAL FIELD

Embodiments of the present disclosure generally relate to systems and methods for providing navigation directions to users via their mobile devices. In particular, embodiments of the present disclosure include an online platform and a mobile application that provide navigation directions for a route, the navigation directions including one or more sensory-based landmarks located along the user's route.

### BACKGROUND AND SUMMARY

People frequently need directions to travel from one place to another. For example, a person visiting from out of town might need directions for a restaurant where he plans to visit a friend. Historically, people have used paper maps for obtaining navigation directions. Recently, with the introduction of digital technology, digital maps have become available as a means of providing directions. Given a starting location, and an ending location, a digital map provides a user with turn-by-turn directions displayed on a digital interface until the user reaches the ending location. Digital maps are now included as mobile applications on mobile phones, tablets, electronic consumer wearable devices such as glasses, watches, etc. Digital maps can also be accessed via a web browser or dedicated navigation devices such as GPS receivers that can be integrated inside, or added as an attachment to, vehicles and boats.

One concern about present digital maps is that directions provided by such maps are cardinal directions that are not helpful to people who are visiting, or otherwise unfamiliar with a particular location or place. For example, “head north on 13th street” might not be very helpful to a foreigner or a person visiting from out of town. Furthermore, in many scenarios, such directions can be confusing. For example, directions such as “head north” or “head west” can be unclear to a person walking along a general direction towards his or her destination, but is not sure of specific turns to make for reaching the destination.

### BRIEF DESCRIPTION OF DRAWINGS

FIG. 1 illustrates an exemplary system for providing navigation directions by a landmark navigation server.

FIG. 2A and FIG. 2B illustrates exemplary screens of a mobile device interface for providing directions to users based on landmarks along a route, according to an embodiment of the present invention.

FIG. 3 illustrates a flow diagram showing a process by a landmark navigation server for determining a route, according to an embodiment of the present invention.

FIG. 4 illustrates a flow diagram showing a process by a landmark navigation server for determining landmarks, according to an embodiment of the present invention.

FIG. 5 illustrates a sequence of operations between a user's mobile application and a landmark navigation server in connection with a route, according to an embodiment of the present invention.

FIG. 6 illustrates a sequence of operations between a user's mobile app and a landmark navigation server in connection with determining a route, according to an embodiment of the present invention.

FIG. 7 illustrates an exemplary database associated with a landmark navigation server, according to an embodiment of the present invention.

FIGS. 8-12 illustrate exemplary screens of a user's mobile device in connection with landmark-based navigation, according to embodiments of the present invention.

FIG. 13 illustrates exemplary mathematical variables used in route calculation, according to an embodiment of the present invention.

FIG. 14 illustrates an exemplary computer system, in connection with landmark-based navigation, according to an embodiment of the present invention.

FIGS. 15-19 illustrate flow-diagrams of a process by which a user logs in to the system and provides or receives navigation-related data in accordance with embodiments of the disclosure.

### DETAILED DESCRIPTION

In one aspect, the inventive disclosure provided herein generally relates to systems and methods for facilitating landmark-based navigation. When a user accesses a landmark navigation server via a mobile application running on a mobile device, the landmark navigation server provides route directions to the user based on landmarks located along the user's route. For example, the directions can be “keep straight towards Smithsonian Museum on Park Place.” A “landmark,” as used herein, is defined as any physical or non-physical element used for orientation. Thus, a landmark can be described according to a visual, haptic, auditory, and/or other sensory-recognized element. Navigation directions, provided by embodiments as disclosed herein, are not limited to street locations as provided by digital maps and publicly available databases, but includes sensory-based cues as part of the navigation guidance for a user for the user's route. Exemplary “landmarks” and their associated navigation directions can include (but not limited to):
Terrain/Elevation Change: E.g., Walk uphill to move towards an intended next location;
Weather Pattern Change: E.g., Walk with wind to move towards an intended next location;
Sun/Moon/Star Location: E.g., Walk towards the sun move towards an intended next location;
Pedestrian Flow: E.g., Walk with pedestrian flow to move towards an intended next location;
Traffic Flow: E.g., Walk against vehicular traffic to move towards an intended next location;
Sound: E.g., Walk towards the loud sounds.

For purposes of discussion, the term “user” is synonymous with and can be used in a similar context as “pedestrian,” “biker,” “runner” or in general, any individual who is physically moving from one place to another and using the disclosed landmark-based mobile application.

In some embodiments, the route directions are given for each turn or segment on the user's route. A user's route is broken down into smaller parts or segments, and a user is provided with navigation directions for each part based on landmarks located along each part of the user's route. In some embodiments, a user is provided with navigation directions for an initial part or segment of the route. As the user keeps moving towards the end of the initial part or segment of the route, additional navigation directions (including landmarks) for the rest of the user's route are provided. Thus, embodiments of the present disclosure dynamically update the navigation directions, based on information relating to movement of the user, the navigation directions including landmarks located along the user's route.

In some embodiments, route directions are provided for the entirety of the user's route In some instances, a user is given an estimate of a time to reach an ending location. In some embodiments, a user is provided with turn-by-turn street directions in addition to the landmark-based navigation directions. Thus, a user can be informed to “turn left at ABC bank” or additionally to, “turn left at P street next to ABC Bank.”

In accordance with aspects as disclosed herein, a mobile application running on a user's mobile device sends and receives data from a landmark navigation server. The landmark navigation server is coupled to a database that stores landmarks located along streets, roads, walkways, highways, etc. Additionally, the database can store various data about landmarks, e.g., in connection with a landmark being visible on a street. When a user launches a mobile application, the mobile application prompts the user to enter a starting location and an ending location (and optionally a current location of a user). Information regarding the starting location and the ending location is sent to the landmark navigation server, which responds, with route information to the mobile application. Via the graphical user interface on the mobile application, the user is then presented with route information, the route information including a heading direction and an orientation with respect to one or more landmarks located along the user's route. For example, a user can be informed to walk towards or away from a particular landmark. The route information provided to a user can also include a graphical display of the user's position and orientation with respect to a next landmark. Aspects of the present disclosure, therefore, provide a heading direction and an orientation to a user, with respect to one or more landmarks on the user's route.

In situations wherein the mobile application determines that a user has “overshot” a designated landmark, then the user is presented with additional landmarks, thereby notifying the user that he or she has gone past the originally-specified landmark. Similarly, if a user has passed the ending location, the user is also presented with a landmark notifying that he or she has traveled past their ending location. It will be appreciated that this functionality can help users to check where they are, enabling the user to re-route accordingly to reach their ending location.

In some aspects, a mobile application can determine a user's current location based on a GPS signal received at the user's mobile device. Such a GPS signal can be a satellite-based signal, a cellular signal from a base station, a Wi-fi signal, a Bluetooth signal, or generally, any form of location-sensing signal. Aspects of the present disclosure can work in scenarios regardless of whether a user has a GPS-enabled mobile device or not. In some scenarios, for example, a user's mobile device may not be equipped with GPS. In some other scenarios, GPS signal received on a user's mobile device may not be strong. In such scenarios, a user can enter a starting location. For example, a user may identify a subway or a mass transit exit location as a starting location of a route. The mobile application can creates suggestions for the mass transit exit location based on a time of day, a last known user location, an ending location, network, mass transit locations, etc.

In some embodiments, a user may provide feedback on the visibility of a landmark. A user can interact with the graphical user interface on the mobile application to provide such feedback. For example, a user can “left swipe” or “right swipe” a picture, arrow, or logo of the landmark on a mobile device screen or hit a “?” or “✓” button, corresponding to the user disagreeing or agreeing that a landmark is visible on the user's route. If a user identifies the landmark as not visible, a secondary landmark can be provided. This process of presenting with an additional landmark, in some embodiments, can continue until, no landmarks are available or, the user has stopped requesting an additional landmark. In some aspects, feedback received from the user can be sent to a landmark navigation server to determine a visibility criteria score for the landmark. The visibility criteria score can be used in identifying whether the landmark is a “suitable candidate,” for landmark-based navigation directions provided to subsequent users.

In addition to user feedback, a visibility criteria score (also referred as “visibility criteria”) can be based on several other factors such as a type of a landmark (a business, a school, a restaurant, a commercial building, a museum, a mall, a retail store, a bank, etc.), a footprint based on a number of businesses operating close to the landmark, a size of the landmark, operating hours of the landmark (if applicable), peak hours of operation (if applicable), an angle of incidence of the landmark's location with respect to a user's location, sensory cues associated with the landmark such as lighting, smell, sound, a credibility factor representing likelihood that the landmark exists, user ratings of the landmark, a date-relevance factor indicating how relevant the landmark is on certain dates (e.g., Macy's New York store may be highly date-relevant during the holiday season), etc. For purposes of this disclosure, the term “landmark” has a broader scope of interpretation.

Aspects of the present disclosure facilitate collection of information about landmarks from a variety of sources. For example, such information can be obtained from geographic databases (both publicly available as well as commercial), users affiliated with the present system, and the like. For example, a user can inform a landmark navigation server about landmarks located along his or her route, using text inputs, camera inputs, or audio inputs, or a combination thereof. These user-identified landmarks are then added to the list of potential landmarks. Such landmarks can be stored in a database that is queried, for navigation directions, when a user's route is determined. In some aspects, the present system assigns a numerical score to a landmark for quantifying a quality of the landmark in being “effectively visible” on a user's route.

In some implementations, the system provides a “user-importance weight” for a user; such a weight can be indicative of how much importance is given to that user's feedback about a landmark. In some implementations, the user-importance weight for a user can be relative to other users' feedbacks. The user-importance weight can also depend on factors such as how useful is the feedback from a user, how long has the user been affiliated with the system, and the like.

In some embodiments, aspects of the present disclosure can operate as a stand-alone mobile application, or can be integrated into other mobile applications. Thus, for example, when a user arrives, by car, at a parking lot at the mall, a third party mobile application running on the user's mobile device can switch (or poll) the disclosed landmark-based mobile application for navigation directions to walk to a store inside the mall. In some aspects, the disclosed landmark-based mobile application, can poll other third party mobile applications, or servers for information. Thus, if a pedestrian who is using the disclosed landmark-based mobile application intends to call a ride sharing service, aspects of the present disclosure are able to offer such service and transitions seamlessly. In some instances, the presently-disclosed mobile application can be integrated into the factory-installed GPS receivers in cars. In some aspects, a user can search for preferred destinations, or points-of-interest for destination categories such as coffee shops, restaurants, retail, salon, movie theater, mall, etc. via the mobile application. In addition, users may receive recommendations from various third-party recommendation engine for identifying destinations with a specific category.

In some embodiments, users can interact with the mobile application. For example, a user can capture photographs of a landmark and send it to a landmark navigation server for sharing with other users. In some scenarios, users can view photographs of landmarks that have been captured by other users, or obtained from geographic databases. Furthermore, users can rate landmarks and provide a rating that quantifies a quality of a particular landmark in identifying a user's route. Users can also save one or more locations (via the mobile application) on their mobile device, e.g., locations that they mostly visit. In some scenarios, users can review the entire quality of a user's route. Users can also review ratings for a landmark. For example, a user can view that a particular restaurant that is a landmark on a user's route has been given a three star rating by other users. Thus, embodiments of the present disclosure utilize a variety of crowd-sourced and third party data sets to provide users with a customized landmark-based navigation experience.

In some aspects, the mobile application can assess various analytics in connection with the “health” of the software and/or the hardware on a user's mobile device. For example, a user can assess a number of times the compass or the GPS receiver on a user's mobile device is working (or, not working). The mobile application can also retrieve information relating to the strength of the GPS signal, etc.

A database server that is in communication with the users' mobile devices logs users' interactions with landmarks explicitly and/or implicitly. This process is created to customize user experience and identify/analyze trends from the gleaned data. Examples of trends may include but are not limited to: brand recognition and walking patterns. This information, for example, can be used by marketers, civic developers and commercial entities to improve walking environments and provide targeted advertising. The psychology of users in a region recognize can also be tracked by a variety of marketing and political groups to identify relevant material for target markets. In some aspects, the mobile application can include a meter, e.g., associated with accelerometers or speed sensors on the user's mobile device. Such a meter can facilitate counts in a number of footsteps taken by a user.

Various aspects and examples of the embodiments will now be described. The following description provides specific details for a thorough understanding and enabling description of these examples. One skilled in the art will understand, however, that the embodiments may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below, however, any terminology intended to be interpreted in any restricted manner will be overtly and specifically defined as such in this Detailed Description section.

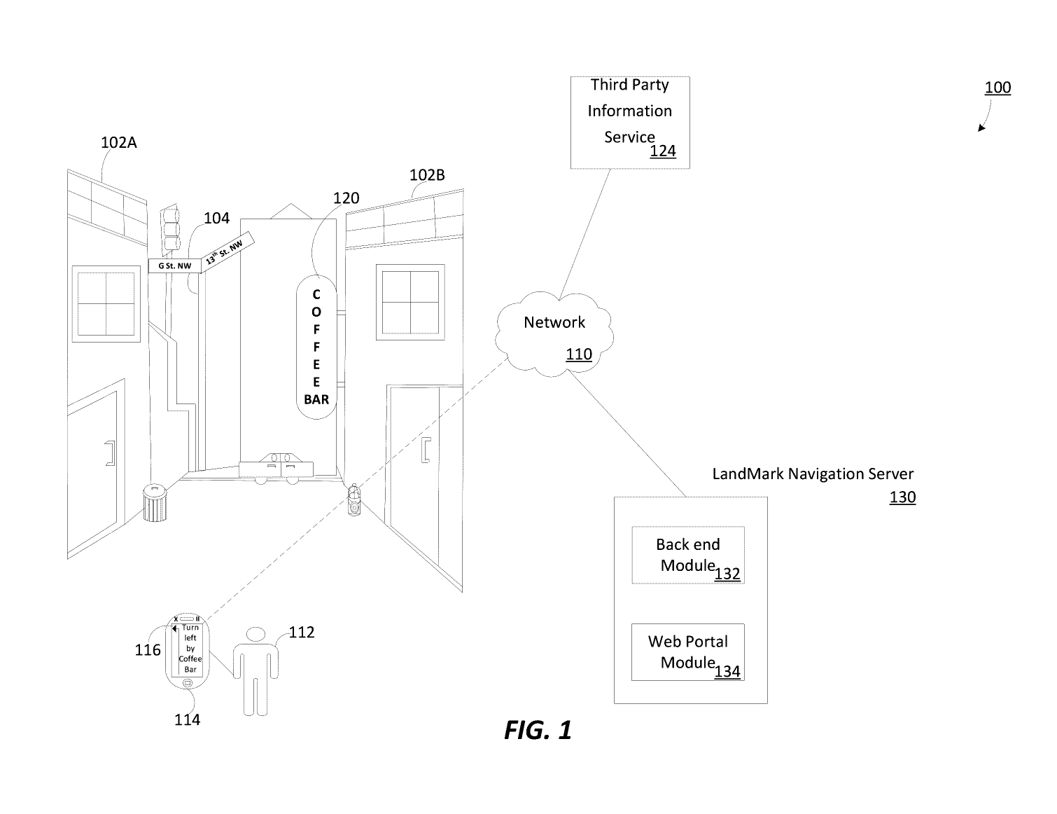

FIG. 1 illustrates an exemplary system where a landmark navigation server 130 facilitates providing navigation directions to users 112 via a user's mobile device 114. Users 120 own, operate, or otherwise have access to mobile devices 114. The navigation direction can be associated with a route that a user 112 intends to take, the route having a starting location and an ending location. Determining a route can involve queries to third party servers such as a third party information service 124. A third party information service 124 can be a geographic database or a server that provides information. The information can be proprietary or publicly available.

A server designed and constructed in accordance with aspects of the present disclosure is referred to herein as a landmark navigation server 130, or simply, landmarks server 130. It will be understood that the term “landmark server” can be a single server or a plurality of interconnected servers that are configured to exchange information. Further, such a server or a plurality of servers can be cloud-based or can be physical servers.

In the exemplary scenario shown in FIG. 1, a user 112 requests route information from a landmark server 130 via the user's mobile device 114. Such route information can be requested by the user or the mobile application sending a starting location and an ending location of the user's route. As shown in FIG. 1, buildings 102 A and 102 B are located along the user's route, as the user is walking towards the intersection of 13th and G street (shown by a pole 104. Additionally, a coffee shop 120 (“Coffee Bar”) is also located along the user's route. The coffee shop 120, for purposes of this example, is identified as a landmark by the landmark server 130.

Upon receiving the route request, the landmark server 130 determines one or more landmarks located along the user's route. In accordance with embodiments as disclosed herein, the landmark server 130 provides the user with navigation directions 116, navigation directions 116 including, for example, a heading direction (turn left) with respect to a landmark (“Coffee Bar”). In some embodiments, the navigation directions 116 can also include street directions, in addition to landmarks, e.g., “turn left on G street by Coffee Bar.”

In some exemplary aspects, the landmark server 130 includes a backend module 132 and a web portal module 134. The (optional) web portal module 134 can, for example, be used by mobile devices via networks 110 to communicate with the landmark server 130. The backend module 134, comprising one or more constituent software modules applies various programs and methodologies to determine landmark-based navigation routes. In some embodiments, the backend module 134 communicates with third party information services 124 via networks 110 to retrieve or send information relating to landmarks. Such information can include (but are not limited to) geographic locations such as expressed by a latitude and a longitude pair, commercial and non-profit entities that provide descriptions, reviews and ratings of landmarks, route information between a starting location and an ending location, image analysis of photographs that identify landmarks within photographs, etc.

Examples of users' mobile devices 112 include but are not limited to tablets, mobile smart phones, personal digital assistants, wearable consumer devices, etc. These mobile devices can run, for example, the popularly-known ANDROID™, IPHONE™, and WINDOWSPHONE™ platforms. It will be understood that there is no limitation imposed on the number of mobile devices, mobile device types, brands, vendors and manufacturers that may be used with embodiments of the present disclosure.

Electronic data communications between elements shown in FIG. 1 can be achieved via one or more networks 110, such as, but not limited to, a Local Area Network (LAN), Wireless Local Area Network (WLAN), Personal area network (PAN), or wireless wide area network (WWAN), enabled with technologies such as Global System for Mobile Communications (GSM), Personal Communications Service (PCS), Bluetooth, Wi-Fi, Fixed Wireless Data, 2G, 2.5G, 3G, 3G LTE, LTE Advanced, 4G, general packet radio service (GPRS), messaging protocols such as, TCP/IP, SMS, MMS, instant messaging, or any other wireless data networks or messaging protocols. Although not shown in FIG. 1, it can be further understood that such communications may include one or more secure networks, gateways, or firewalls that provide information security from unwarranted intrusions and cyber attacks. In some embodiments, the landmark server 130 includes functionality to allow it to communicate, for example, by using application programming interfaces (APIs), with various elements shown in FIG. 1.

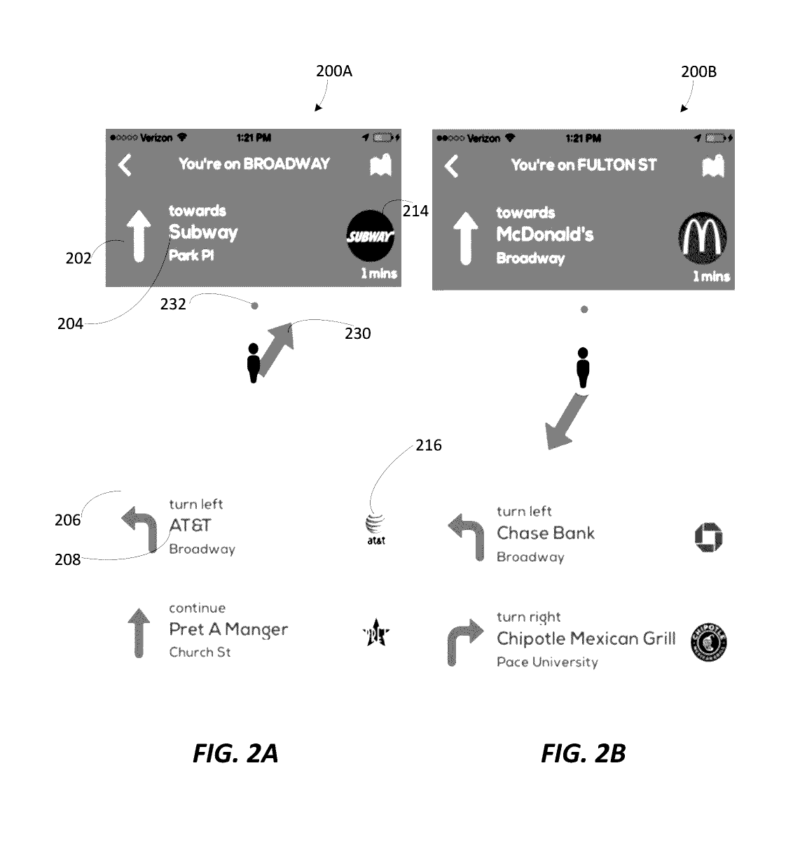

FIG. 2A and FIG. 2B illustrates exemplary screens 200A and 200B of a mobile device interface for providing directions to users based on landmarks along a route, according to an embodiment of the present invention. For example, screen 200A shows a direction indicator 202 (“walk straight”), a landmark 204 (“Subway”) along with its logo 214, a heading 230 of the user with respect to a landmark 232. Screen 200A also shows subsequent direction steps 206 (“turn left”) associated with a landmark 208 (“AT&T”) along with its logo 216. Providing a logo as part of the navigation directions can be optional, and thus a landmark might not have a logo associated with it.

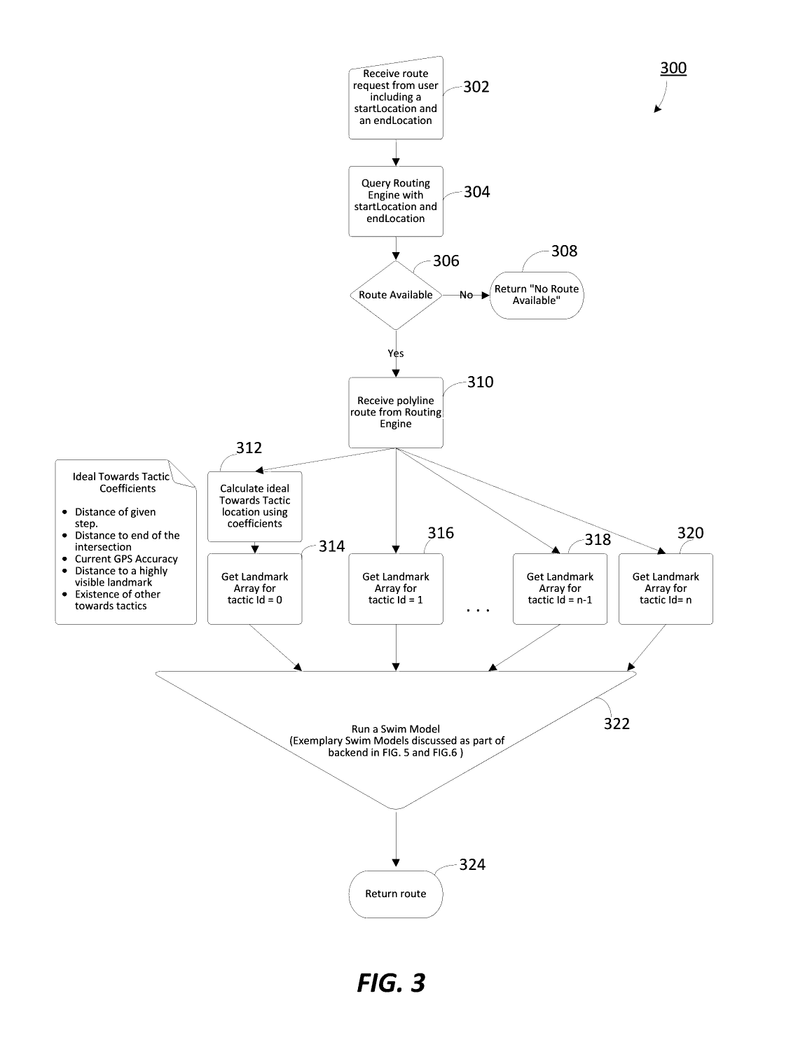

FIG. 3 illustrates a flow diagram showing a process performed by a landmark navigation server for determining a route, according to an embodiment of the present invention. Starting at step 302, a landmark server receives a route request from a user's mobile device, the route request including a starting location and an ending location. The starting location and the ending location, can for example, be entered by a user via a graphical user interface of a mobile application running on the user's mobile device. In some scenarios, a user can enter only a starting location, and choose from an ending location from a list of preferred destinations, points-of-interest, or saved locations on the user's mobile device. In some aspects, a mobile application can determine a user's starting location automatically based on a location-sensing mechanism such as a GPS signal received from the user's mobile device. Such a GPS signal can be a satellite-based signal, a cellular signal from a base station, a Wi-fi signal, a Bluetooth signal, or generally, any form of location-sensing signal. Aspects of the present disclosure can work in scenarios regardless of whether a user has a GPS-enabled mobile device or not. At step 304, the landmark server queries a routing engine with the starting location and the ending location. The routing engine can be operated by the entity associated with the landmark server, or it can be a third party routing engine (e.g., a geocoding server). At step 306, the landmark server determines if there is a route available or not. If there is no route available, the process returns “a no route available” message to the user at step 306, and returns back to step 302. If there is a route available, the process receives a route from the routing engine, at step 310. The route can be generally a polyline route, which is multi-step route composed of a set of segments or steps between a starting location and an ending location. Each segment of a polyline route includes directions for a turn or a keep straight with respect to a road, street, lane, walkway, passageway, etc. Further, each segment can be identified according to an identifier such as ID0, ID1, ID2, . . . ID(n−1), IDn and so on. The routing engine can be coupled to the landmark server, or it can be affiliated with a third party information source such as a geographic server.

For purposes of this discussion, a “landmark” is defined as any physical or non-physical element used for orientation. Thus, a landmark can be described according to a visual, haptic, auditory, and/or other sensory-recognized element. The term landmark array has been used for discussion examples herein. A landmark array is an exemplary data structure storing, representing, or pointing to a collection of landmarks, and information associated with such landmarks. In alternate embodiments, different data structures can be used for handling and manipulating landmark data.

Further, for purposes of illustration, navigation direction associated with each step or segment of a user's route is defined as a “tactic.” A tactic includes a heading direction, an orientation, and one or more landmarks associated with the heading direction and the orientation. The first tactic on the user's route is referred in FIG. 3 as a “towards tactic.” At step 312, the process calculates an ideal “towards tactic,” using the first segment of the polyline route, the segment identified as ID0. In some aspects, calculation of the towards tactic is based on length of a the segment ID0, the distance between the starting location and the end of the segment ID0, a factor relating to GPS accuracy, a distance between the starting location and a landmark regarded as highly visible.

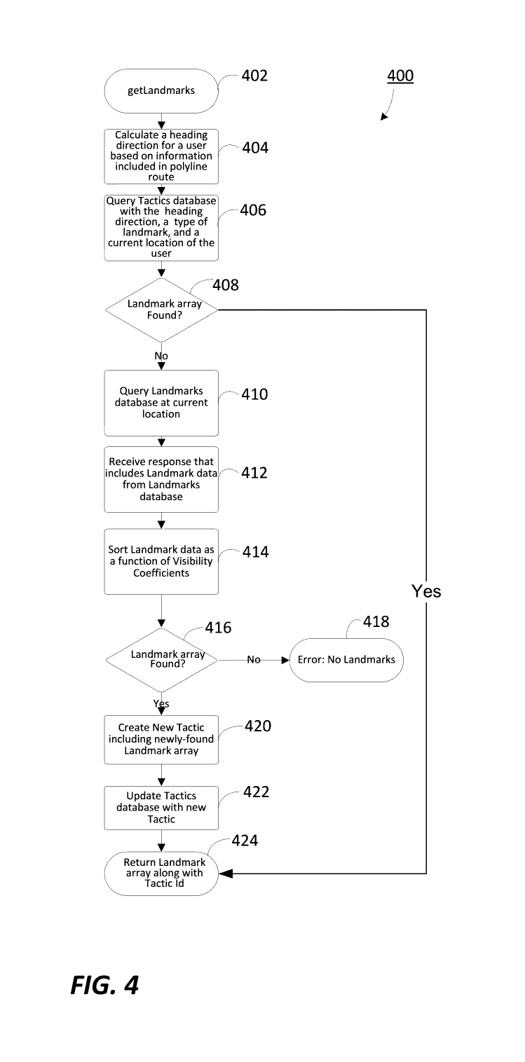

After the calculation of the ideal towards tactic, the process performs steps 314, 316, 318, 320 in parallel. These steps correspond to determining (shown in detail in FIG. 4) a landmark array for each of the segments with identifiers ID0, ID1, ID(n−1), and IDn. That is, the process calculates, in parallel, a landmark array for each of the segments on the user's route, each segment identified by the polyline route received from the routing engine. In some embodiments, the process only calculates a landmark array for ID0 and provides it to the user. While the user moved towards the end of the segment ID0, the process, calculates landmark arrays for the remaining segments or parts of the user's route. The process can provide the user with navigation directions (including landmark arrays) for the remaining parts of the user's route, upon determining (e.g., using location information received from the user's mobile device) that the user has reached the end of segment ID0.

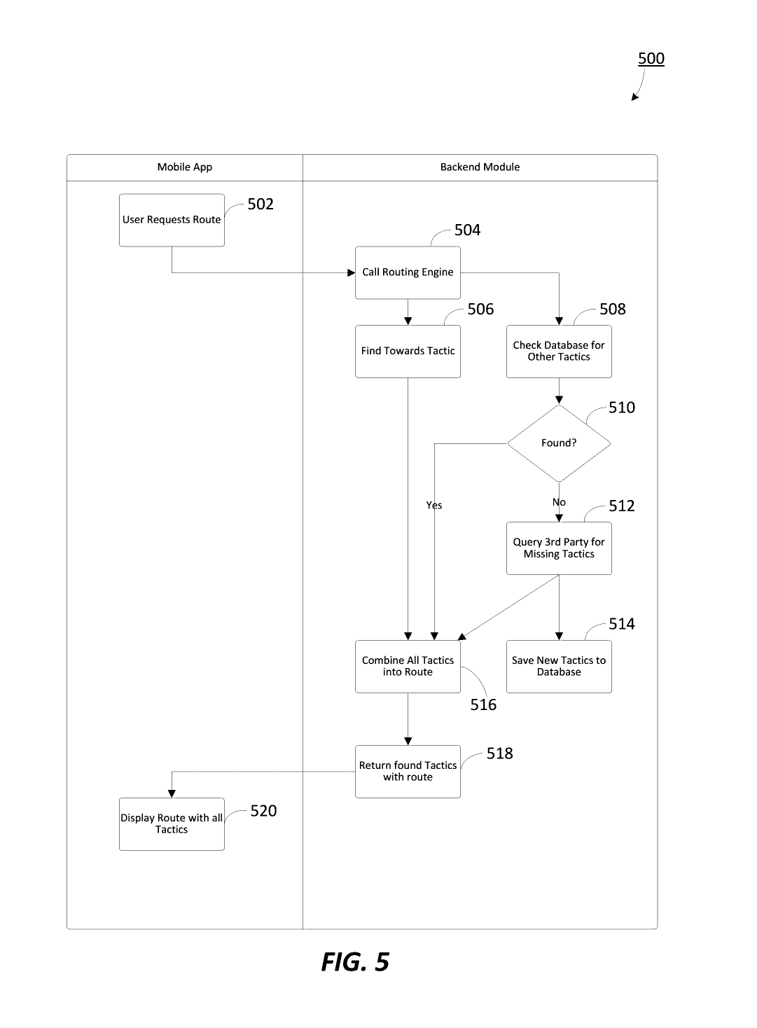

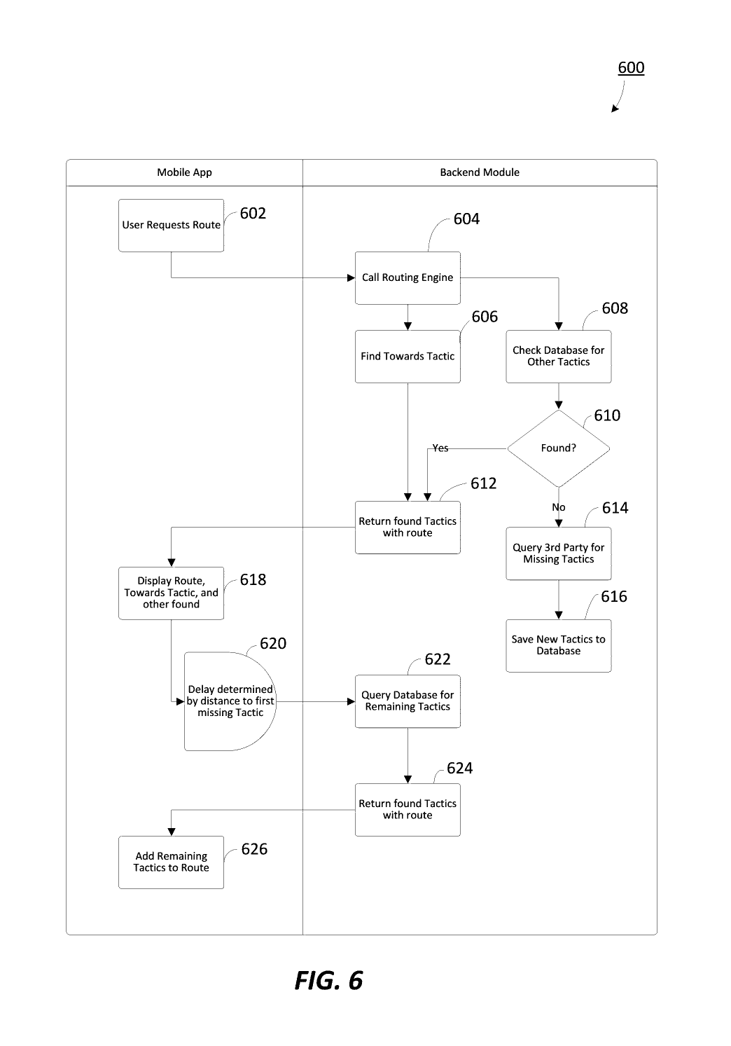

In some other embodiments, the process can provide the user with navigation directions (including landmark arrays) for the remaining parts of the user's route, while the user is moving along segment ID0. This implies that the process dynamically updates the initial landmark array with additional landmark arrays while detecting (e.g., using location information received from the user's mobile device) user movement along an initial part of the user's route. This way of calculating an initial landmark array for an initial part of the user's route, providing the user with the initial landmark array, and dynamically updating the landmark array while the user is in motion results in a faster delivery time of providing navigation directions to the user, compared to a scenario wherein the process calculates landmark arrays for the entirety (i.e., for every segment) of the user's route before providing navigation directions to the user. Embodiments directed at calculation of an initial landmark array followed by dynamically updating the initial landmark array, and embodiments directed at landmark array calculation for the entirety of the user's route are discussed in connection with a swim model (step 322) discussed in FIG. 6 and FIG. 5 respectively. The process returns the route information (partially or in full, based on the swim mode used) to the user at step 324.

FIG. 4 illustrates a flow diagram showing process steps by a landmark navigation server for determining landmarks, according to an embodiment of the present invention. At step 420, the process enters a getLandmarks subroutine. (It will be understood by one of ordinary skill in the art that this subroutine can be called by another subroutine or process, for example, a landmark server process shown in FIG. 3.) At step 404, the process calculates a heading direction for the user based on information in the polyline route. This information, can for example depend on a latitude and a longitude pair associated with each segment of the polyline route. After calculation of the heading, the process queries a database with the heading, a type of a landmark, and a current location of the user, at step 406. (A current location of the user can be received by the process, from a location-sensing signal sent by the mobile application on the user's mobile device.) Examples of types of landmarks include (but are not limited to) a business, a school, a restaurant, a commercial building, a museum, a mall, a retail store, a bank, and the like. At step 408, the process determines, from a response of the database, whether or not a landmark array can be created. If the process determines that a landmark array has been created, then the process jumps to step 424 where it returns the landmark array to the calling process, and exits the getLandmarks process.

If the process determines that a landmark array is not created, then it queries (step 410) a landmarks database with a current location of the user. At step 412, the process receives a response from the landmarks database, the response including landmark data. The process sorts the landmark data according to visibility criteria, at step 414. Visibility criteria represent the quality of a landmark being visible on a user's route. Examples of visibility criteria include (but are not limited to), a type of a landmark (a business, a school, a restaurant, a commercial building, a museum, a mall, a retail store, a bank, etc.), a footprint based on a number of businesses operating close to the landmark, a size of the landmark, operating hours of the landmark (if applicable), peak hours of operation (if applicable), an angle of incidence of the landmark's location with respect to a user's location, sensory cues associated with the landmark such as lighting, smell, sound, a credibility factor representing likelihood that the landmark exists, user ratings of the landmark, a date-relevance factor indicating how relevant the landmark is on certain dates (e.g., Macy's New York store may be highly date-relevant during the holiday season), etc.

At step 416, the process determines whether or not a landmark array can be created. If the process determines that no landmark array has been created, then the process jumps to step 424 where it returns the landmark array to the calling process, and exits the getLandmarks process. If the process determines that no landmark array can be created, then it returns an error message to the calling process or subroutines, and terminates the getLandmarks process.

If the process determines that a landmark array is created, then the process moves to step 420 where it creates a new tactic with the newly-returned landmark array. A tactic is defined as a set of data including a heading direction, a current location (e.g., a latitude longitude pair), a type (e.g., left turn, right turn, keep straight), and a landmark array storing one or more landmarks associated with the tactic. At step 424, the process returns the landmark array to the calling process or subroutine, and exits the getLanmdarks subroutine. In some embodiments, the process optionally updates a database with the new tactic.

FIG. 5 illustrates a sequence of operations between a user's mobile app and a landmark server, according to an embodiment of the present invention. FIG. 5 corresponds to an embodiment directed at landmark array calculation for the entirety of the user's route. At step 502, a user requests a route via a mobile app running on a user's mobile device. Such a request includes a starting location and an ending location and is received by the landmark server, for example, a backend module of a landmark navigation server. The landmark server calls a routing engine 504 for a polyline route. Using the polyline routine, the landmark server calculates in parallel at steps 506 and 508 respectively, a “towards tactic” (e.g., associated with a first segment of the polyline route) and other “tactics” associated with remaining segments of the polyline route. A tactic includes a heading direction, an orientation, and one or more landmarks associated with the heading direction and the orientation. The first tactic on the user's route is referred as a “towards tactic.” Calculation of the other tactics can require the landmark server to check with a database for pre-stored tactics. At step 510, the landmark server determines if the remaining tactics have been calculated or retrieved from a database. If one or more of the remaining tactics are not found, then the landmark server queries (at step 512) third party databases to obtain landmark information for the segments in which tactics could not be calculated. Upon receiving landmark information from the databases, the landmark server calculates the tactics, and saves them in a database at step 514. At step 516, the landmark server combines all the tactics for the entirety of the user's route, i.e., the towards tactic and the remaining tactics. Then, the landmark server provides the route (including all the tactics) to the user's mobile application. The user's mobile application receives the route with all the tactics and displays the navigation direction including the tactics on a screen of the user's mobile device.

FIG. 6 illustrates a sequence of operations between a user's mobile app and a landmark navigation server, according to an embodiment of the present invention. FIG. 6 corresponds to an embodiment directed at calculation of an initial landmark array followed by dynamically updating the initial landmark array while a user is moving along an initial segment of the user's route. At step 602, a user requests a route via a mobile app running on a user's mobile device. Such a request includes a starting location and an ending location and is received by the landmark server, for example, a backend module of a landmark navigation server. The landmark server calls a routing engine 604 for a polyline route. Using the polyline routine, the landmark server calculates in parallel at steps 606 and 608 respectively, a “towards tactic” and other “tactics” associated with remaining segments of the polyline route. Calculation of the other tactics can require the landmark server to check with a database for pre-stored tactics. At step 610, the landmark server determines if the remaining tactics have been calculated or retrieved from a database. If one or more of the remaining tactics are not found, then the landmark server queries (at step 614) third party databases to obtain landmark information for the segments in which tactics could not be calculated. Upon receiving landmark information from the databases, the landmark server calculates the tactics, and saves them in a database at step 616.

At step 612, the landmark server returns the tactics that have been calculated and/or found otherwise, to the user, while the user is moving along the initial segment of the user's route. That is, in accordance with this embodiment, the landmark server provides the tactics included as part of the navigation directions, to the user, while calculating the missing tactics. As and when tactics pertinent to a user's route are found, such tactics are provided to the user on-the-fly. At step 618, the mobile application displays the tactics received from the landmark server, to a user. In some embodiments, if the missing tactic cannot be readily calculated, the mobile application, the landmark server estimates an approximate delay based on a distance between the user's current location and the missing tactic. Duration of such a delay can be communicated (step 620) optionally, to a user's mobile application. At step 622, the landmark server queries a database for landmark information relating to the remaining (missing) tactics. Upon receiving (at step 624) landmark information from the database, the landmark server adds provides the missing tactics to the mobile application. The mobile application updates the navigation direction based on the missing tactic, and provides the route to the user.

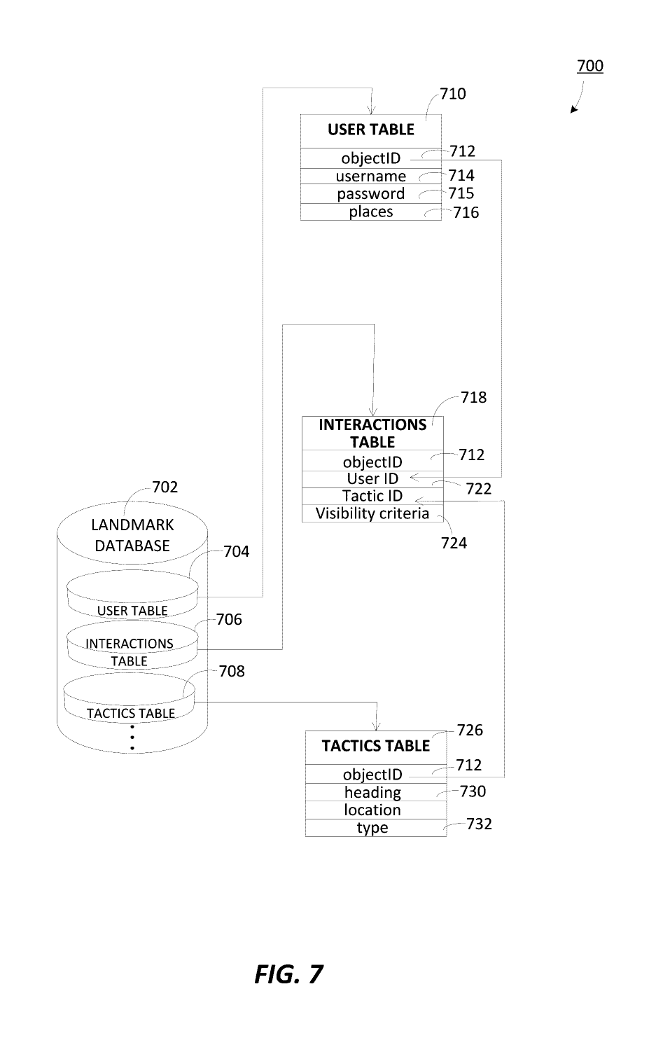

FIG. 7 illustrates an exemplary database associated with a landmark navigation server, according to an embodiment of the present invention. Specifically, FIG. 7 shows a landmark database 702 including a user table 704, an interactions table 706, and a tactics table 708. The user table 710 includes information identifying a user who requests route information from the landmark server via a mobile application. The user table 704 comprises objectID variable 712, a username variable 714, a password variable 715, and a places variable 716. The places variable 716, for example, can indicate one or more routes that a user has requested. The objectID variable 712 is an identifier for uniquely identifying data objects in the user table 704, the interactions table 706, and the tactics table 708. The interactions table 718 includes an objectID variable 712, a userID variable 722, a TacticID variable 722, and Visibility Criteria 724. The TacticID variable 722 uniquely identifies a tactic in the interactions table 718. A tactic is defined as a set of data including a heading direction, a current location (e.g., a latitude longitude pair), a type (e.g., left turn, right turn, keep straight), and a landmark array storing one or more landmarks associated with the tactic. The visibility criteria variable 724 relates to a numerical score for quantifying a quality of the landmark in being “effectively visible” on a user's route. The tactics table 726 includes an objectID variable 712, a heading variable 730, a location variable 731, and a type variable 732. A type variable 732 indicates a type of a landmark. Examples of types of landmarks include (but are not limited to) a business, a school, a restaurant, a commercial building, a museum, a mall, a retail store, a bank, and the like.

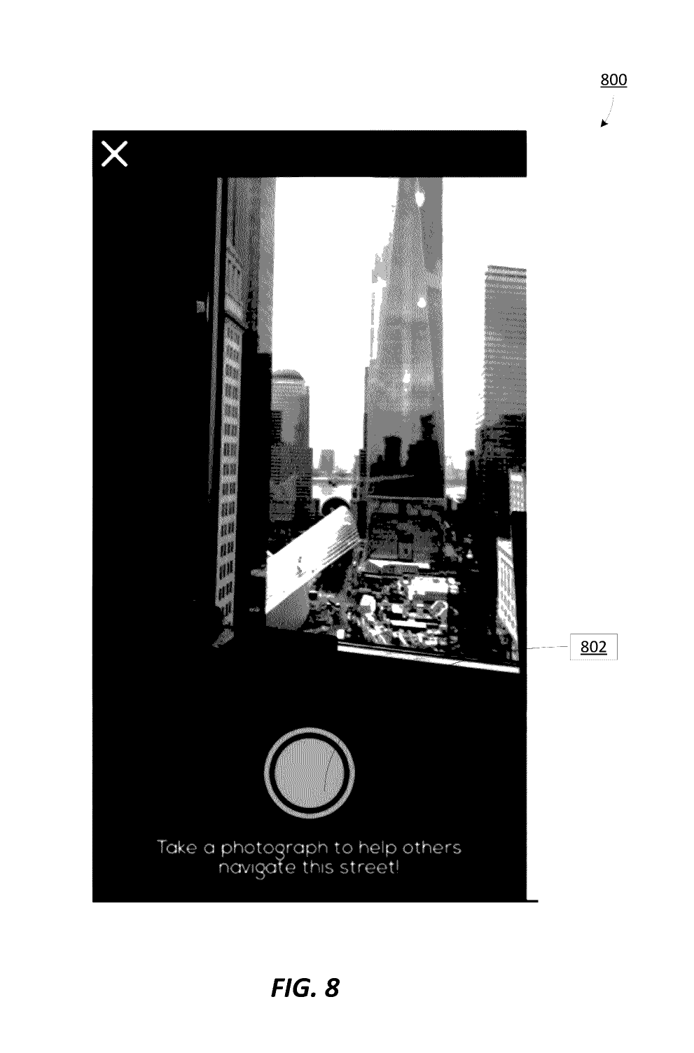

FIGS. 8-12 illustrate exemplary screens of a user's mobile device in connection with landmark-based navigation, according to embodiments of the present invention. Specifically, FIG. 8 shows a screen of a mobile device with the camera of the mobile device capturing a photograph of a landmark. For example, a user of the mobile device can click on button 802 to capture a photograph of the mobile device. Such a photograph can be uploaded to a landmark navigation server, and added to a landmark database. Thus, embodiments of the present disclosure facilitate integration of user-generated content (e.g., photographs) into a landmark database that can, subsequently, be used in navigation directions for user routes.

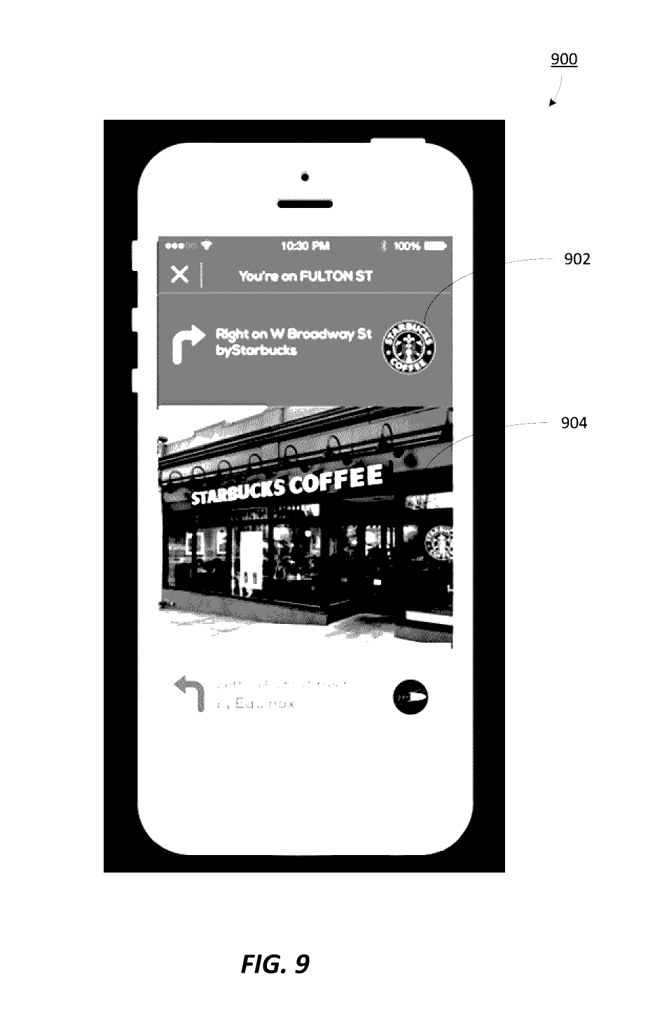

Referring to FIG. 9, an exemplary screen 900 of a user's mobile device is shown displaying navigation directions to a user. The user is provided with navigation directions associated with a Starbucks landmark, e.g., “right on Broadway Street by Starbucks.” Additionally, a logo 902 of the landmark is shown as part of the navigation directions. Also shown, in region 904, is a photograph of the landmark. As discussed previously, in some scenarios, such photographs can be captured by users, and uploaded to the landmark navigation server for landmark-based route navigation.

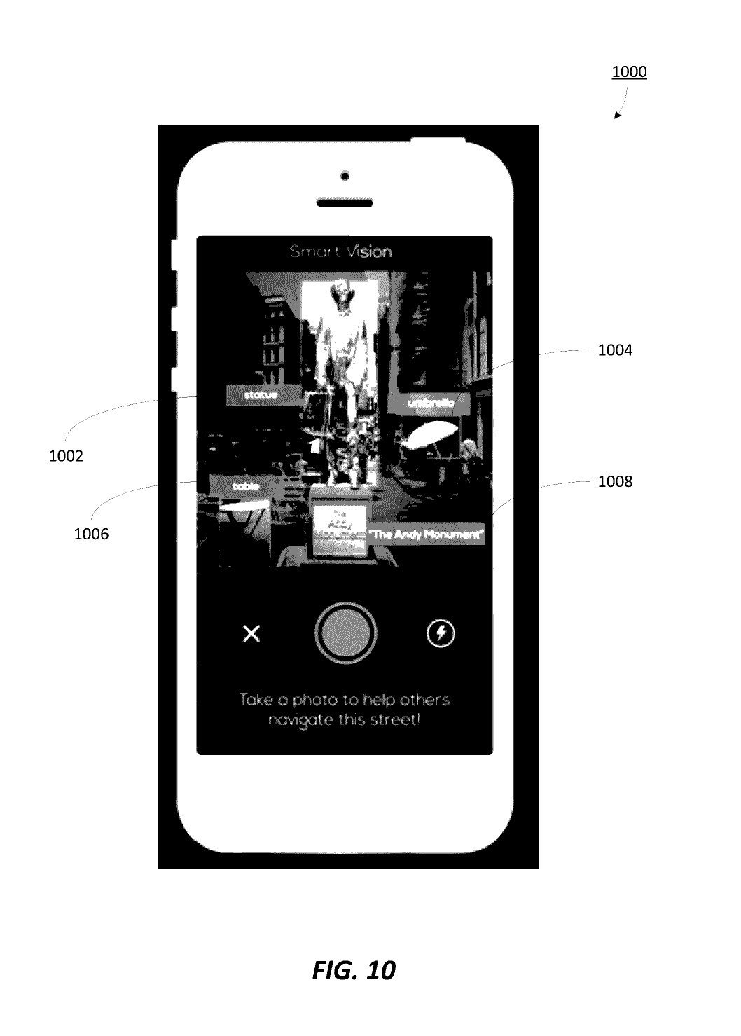

An exemplary screen 1000 of a user's mobile device is shown in FIG. 10. FIG. 10 shows a statue 1002, an umbrella 1004, a table 1006, and a monument 1008, included in a photograph. Aspects of the present disclosure facilitate the identification of various elements (e.g., umbrella, table, etc.) in an image, for example, using computer vision methodologies of image recognition. In an exemplary scenario, a user captures a photograph using his or her mobile device. The disclosed landmark-based mobile application identifies various elements in the photograph. The photograph along with the identified elements is then sent to a landmark navigation server which adds the photograph into a landmark database. In some embodiments, the photograph is sent to the landmark navigation server as-is, and the computer vision methodologies are applied by the server to identify the elements included in the photograph.

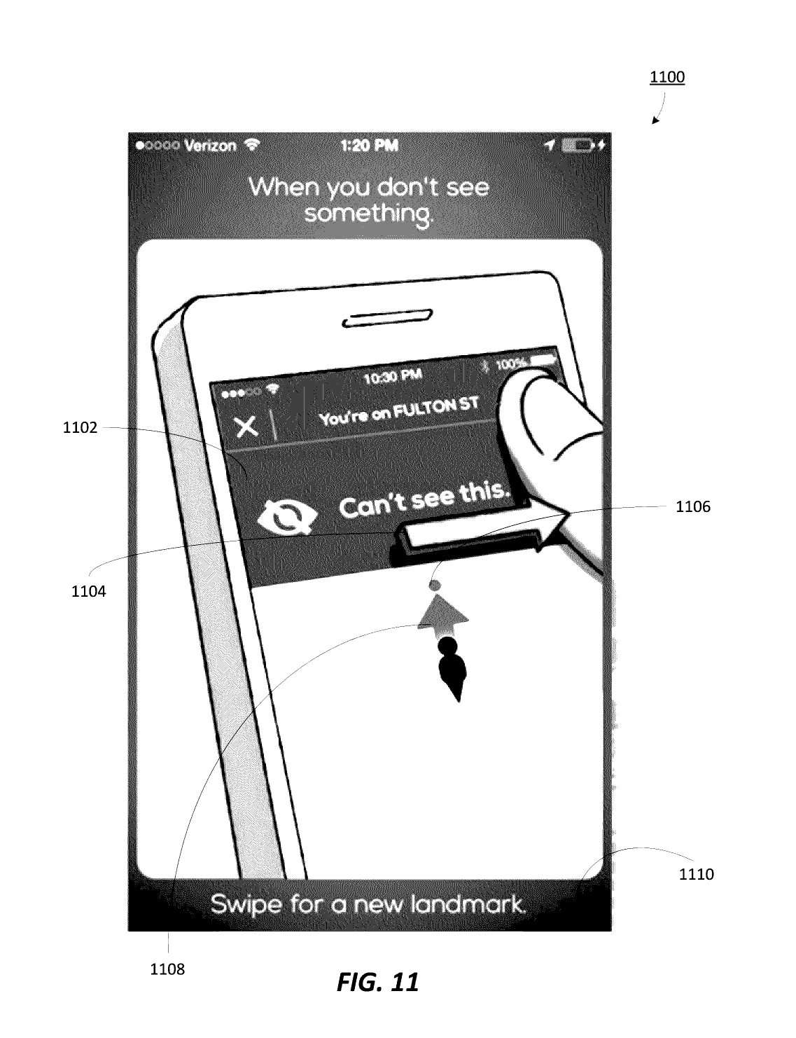

FIG. 11 illustrates a user's selection of whether a landmark is useful in connection with being visible on a user's route. Users, for example, are given the option to “left swipe” or “right swipe” the landmark with an arrow 1104 by agreeing or disagreeing to its usefulness in being visible on a user's route, as shown in region 1102. Additionally, FIG. 11 shows a direction indicator 1108 and a button 1106 corresponding to a heading direction and an orientation (with respect to an intended landmark. FIG. 11 also shows a region 110 which informs the user to swipe across the screen for viewing a new landmark.

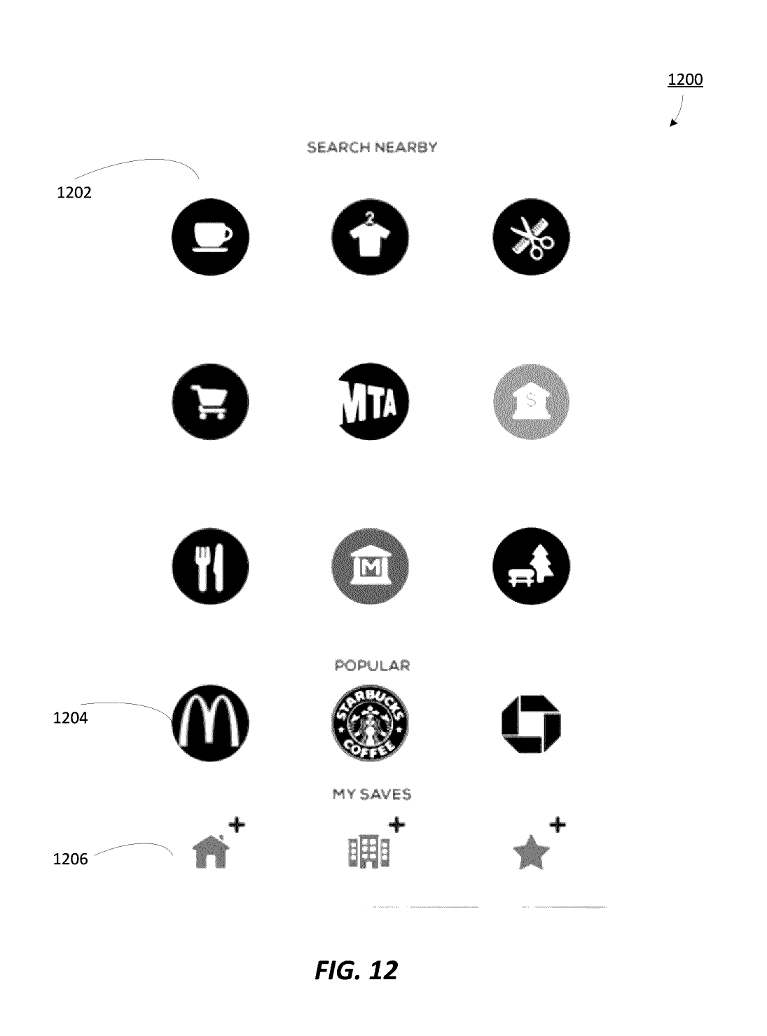

FIG. 12 shows a user's mobile device screen 1200 displaying various categories of destinations. For example, region 1202 shows coffee shops, dry cleaners, barber shops, mass transit, restaurants, financial institutions, etc. In region 1204 of FIG. 12, a few popular categories of destinations are displayed, e.g., McDonalds fast food, Starbucks coffee, etc. Region 1206 of FIG. 12 displays various categories of destinations that have been selected by the user, and data pertaining to these categories can be saved in the user's mobile device via the mobile application.

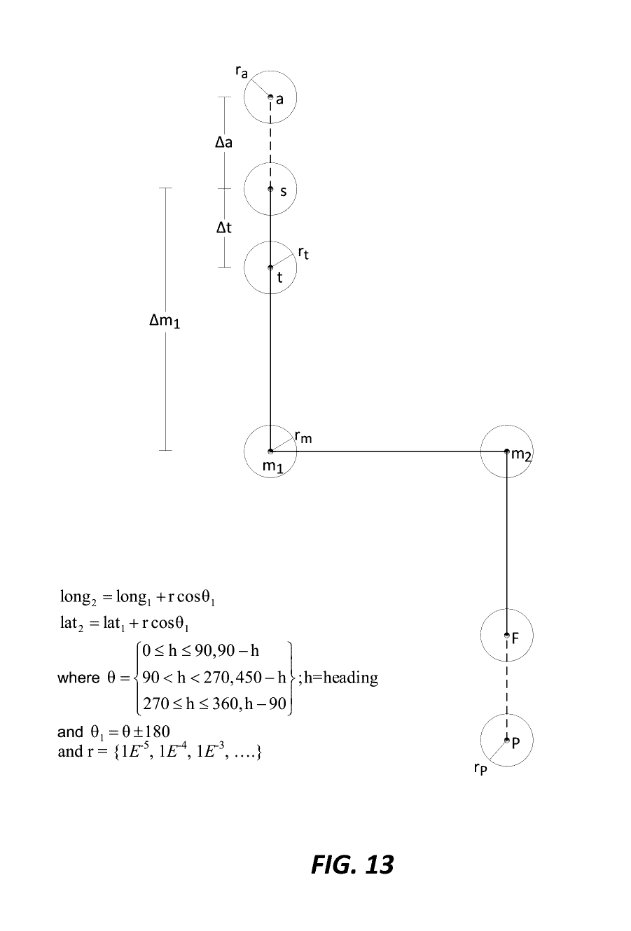

Referring to FIG. 13, exemplary mathematical variables used in route calculation are shown, according to an embodiment of the present invention. Specifically, FIG. 13 shows a sample route in which point (s) is designated as a start location, and (f) represents the finish (or, ending) location. Points (m1) and (m2) correspond to intermediate locations at which a user moving along the intended route, is expected to perform an action. The line segment between point (s) and point (m1) along with the action taken at point (m1) represents a step (or, segment) of the route.

Given a user's starting location and an ending location, a routes may be initially determined by a call to a routing engine, such as Google or Mapbox, for example. Such a route is typically a polyline route comprising a collection of segments or parts. A landmark server then decomposes this polyline route into individual segments for calculating the “ideal” landmark(s) along each segment of the polyline route. The segments are defined as straight line or approximately straight line segments between two points, each point identified by a latitude and longitude pair. In some scenarios, a segment less than an extended distance. A sorted collection of landmarks is then presented to the user for each step using the latitude and longitude coordinates of the maneuver location (mₙ) as the central location. In addition to step landmarks, orientation landmarks are calculated using the navigation heading of the first step of the route. A selected maneuver location is determined using a distance parameter (d) and the navigation heading (h) of the first step of the route as a function of the reference angle (θ) where: towards_location=start_location+d∠θ; and away_location=start_location+d∠(θ+180). According to aspects of the present disclosure, distance designation value (d) is translated according to values of Δt and Δa where point (a) defines a location as a reference point in the opposite direction of the intended route and point (t) defines a location as a reference point in the direction of the route. In addition a radius value determined as rₐ rₜ rₘ is defined by landmark density at a location and represents a given radius from the reference point in which acceptable landmarks can be found.

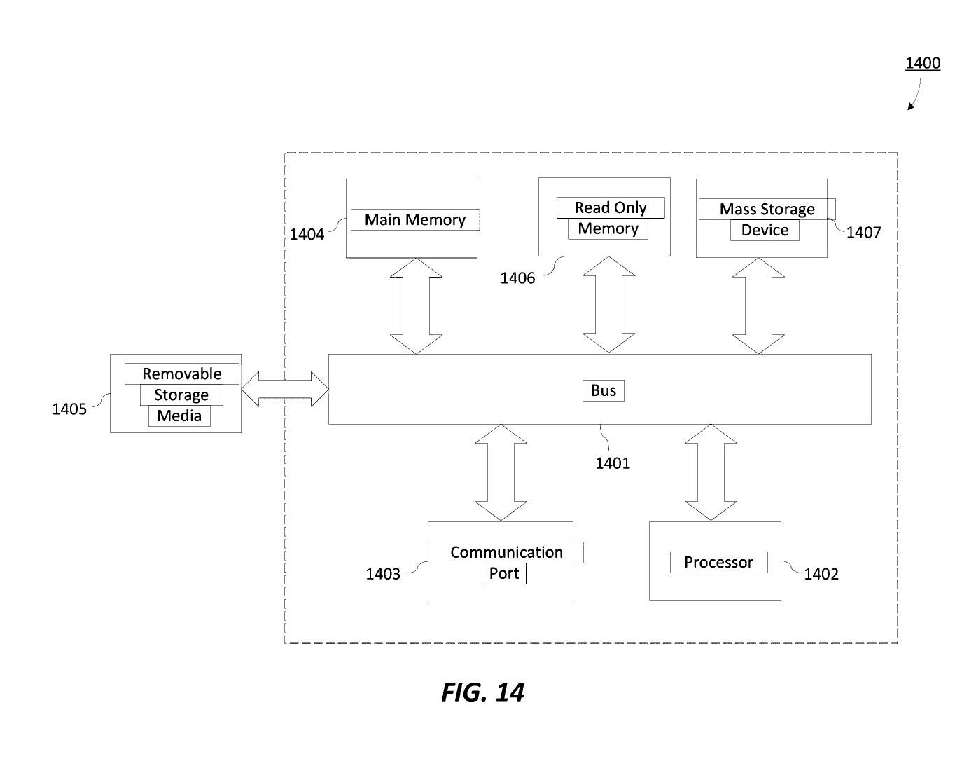

Referring to FIG. 14, an exemplary computer system 1400, representing an exemplary server or client system, with which various features of the present invention may be utilized, will now be described with reference to FIG. A. In this simplified example, the computer system 1400 comprises a bus 1401 or other communication means for communicating data and control information, and one or more processors 1402, such as Intel® Itanium® or Itanium 2 processors, coupled with bus 1401.

Computer system 1400 further comprises a random access memory (RAM) or other dynamic storage device (referred to as main memory 1404), coupled to bus 1401 for storing information and instructions to be executed by processor(s) 1402. Main memory 1404 also may be used for storing temporary variables or other intermediate information during execution of instructions by processor(s) 1402.

Computer system 1400 also comprises a read only memory (ROM) 1406 and/or other static storage device coupled to bus 1401 for storing static information and instructions for processor(s) 1402. A mass storage device 1407, such as a magnetic disk or optical disc and its corresponding drive, may also be coupled to bus 1401 for storing information and instructions. One or more communication ports 1403 may also be coupled to bus 1401 for supporting network connections and communication of information to/from the computer system 1400 by way of a Local Area Network (LAN), Wide Area Network (WAN), the Internet, or the public switched telephone network (PSTN), for example. The communication ports 1403 may include various combinations of well-known interfaces, such as one or more modems to provide dial up capability, one or more 10/100 Ethernet ports, one or more Gigabit Ethernet ports (fiber and/or copper), or other well-known network interfaces commonly used in current or future internetwork environments. The communications ports 1403 may also include specialized interfaces to provide a capability to inject SIGNATURE information into an electric power network, and/or to detect SIGNATURE information which has previously been injected into the network. In any event, in this manner, the computer system 1400 may be coupled to a number of other network devices, clients, and/or servers via a conventional network infrastructure, such as an enterprise's Intranet and/or the Internet, for example.

Optionally, operator and administrative interfaces (not shown), such as a display, keyboard, and a cursor control device, may also be coupled to bus 1401 to support direct operator interaction with computer system 1400. Other operator and administrative interfaces can be provided through network connections connected through communication ports 1403.

Finally, removable storage media 1405, such as one or more external or removable hard drives, tapes, floppy disks, magneto-optical discs, compact disk-read-only memories (CD-ROMs), compact disk writable memories (CD-R, CD-RW), digital versatile discs or digital video discs (DVDs) (e.g., DVD-ROMs and DVD+RW), Zip disks, or USB memory devices, e.g., thumb drives or flash cards, may be coupled to bus 1401 via corresponding drives, ports or slots.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), field programmable gate arrays (FPGAs), application-specific integrated circuits (ASICs), vehicle identity modules (VIMs), magnetic or optical cards, flash memory, or other type of media/machine-readable medium suitable for storing electronic instructions.

Moreover, embodiments of the present invention may also be downloaded as a computer program product or data to be used by a computer program product, wherein the program, data, and/or instructions may be transferred from a remote computer to a requesting computer by way of data signals embodied in a carrier wave or other propagation medium via a communication link (e.g., a modem or network connection). For some parts of the program, data or instructions, this communication link may include the power transmission facilities (“in-band”). For other parts of the program, data, or instructions, this communication link may include external networks such as the telephony network (e.g., Public Switched Telephony Network, cellular, wifi, and other voice and wireless networks) or the Internet (“out-of-band”). In some cases, the communications link may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, and/or a module can include one or more application programs. The term “responsive” includes completely and partially responsive.

The various illustrations and teachings provided herein can also be applied to systems other than the system described above. The elements and acts of the various examples described above can be combined to provide further implementations of the embodiments. For example, in addition to, or alternatively, embodiments of the present disclosure facilitate intelligent city exploration to users through various, relevant data. A mobile navigation application (or “app”) accesses a variety of crowd-sourced and third party data sets to provide users with a customized navigation experience. Users may interact with the application by reporting stories, getting directions, and voting on the veracity or usefulness of others' stories.

Users are prompted via a graphical user interface in the application to input, categorize, and rate incidents believed to be potentially unsafe, unusual, or otherwise an impediment to navigating a walkway. Via the graphical user interface, a user may enter a number of fields, including but not limited to: the category of event, time of day, date of incident, lighting conditions, amount of people present, incident intensity, and text details regarding what happened. Users also may upload a photo or document the event in other ways. By soliciting this input, crowd-sourced data is associated with mapping data.

Users also can access the graphical user interface in the application to search for destinations and see what data exists that pertains to a user's area of interest. In addition, users may obtain sophisticated navigation directions from a starting location to a destination. Beyond receiving the time and distance to the destination, a user can access the application to receive a numerical rating regarding the relative safety or desirability of the transit based on the user's preferences.

$$Route \# = {\sum }_{t = 0}^{steps} {\sum }_{t = 0}^{points} point score$$

$$Point Score = Type ⋆ Int ⋆ User ⋆ ToD ⋆ Dist ⋆ Date$$

$$Where 0 < PointScore < 1$$

Users can report or receive information relating to an event, incident, or disturbance, according to various parameters, such as the following:
Type=Type of Event Weight
   Ex. Murder=10; Assault=5; CatCall=1
User=Weighted User Preference
   Defined by user's interaction with app.
Int=Intensity
   1-5 determined by crowd votes
ToD=Weighted Time Of Day
   Length from current time.
   Ex. Current Late Night
      Point—Late Night : TOD=1
      Point—Evening: TOD=0.5
Dist=Weight Distance from Path
   Within value X; distance=1
   Greater than X; distance=1−delta
   Delta=1 at max distance of Y;
Date=Weight Date
   Length from current date.
   0-1.

Incidents and data sets may include, but are not limited to, the presence (or lack thereof) of crime, human presence, human interaction, lighting, unordinary human movement, harassment, assault, racial profiling, begging, open/closed business, vacant structures/spaces, animal presence, animal interaction, unordinary animal movement, advertising, political advertising/campaigning, humorous interactions, entertainment, aesthetics, architecture, green space, artwork/graffiti, traffic lights/stops, cleanliness, pathway availability, pathway assistance, beacons/hand rails, surface quality/structure, elevation, elevation change, shade, rain shelter, food/commerce availability, alternative transit, power charging/fueling, cellular availability, historical significance, weather/emergency routes, scams, illicit transaction, congestion, noise, smell, limited sight, known traffic accident, air pollution, water pollution, weather conditions, paint/maintenance, new-ness, breeze, temperature, heat/air conditioning, pathway shortcuts, insects/pests, religious institutions, restroom availability, water fountains, or trash.

Users can engage the application by viewing other users' reported incidents and, for example, voting on the level of concern attributed to the incidents. Users may choose to “upvote” or “downvote” the incident by agreeing to a level of concern—e.g. citing a similar incident—disagreeing with the level of concern—e.g. claiming an incident is nothing more than an offensive report—or reporting spam. “Upvote” and “downvote” are an action taken by the user to agree with or disagree with whether or not the point or location they are viewing is disreputable. Users can also use the “downvote” action to flag as abuse or spam. A “Point” (or incident) is defined as a piece of information created by a user via the mobile app. A “report” is defined as the textual details of that point or location. A “point” is defined as a general piece of geo-tagged (e.g. latitude, longitude) information that can either be from the database associated with the disclosed system, or an outside (3^{rd} Party) Database (e.g. crime data, public transit, etc.).

A database server that is in communication with the users' client devices logs users' interactions with incidents/stories. This process is created to customize the users' experience and identify/analyze trends in the data gleaned. Examples of trends may include but are not limited to: light outages, crime, and walking patterns. This information can be used by energy companies, civic developers, and other commerce industries for determining lighting demands, transportation demands, security demands, and commerce opportunities. The psychology of what users in a region determine to raise a concern can also be used by a variety of marketing and political groups to create relevant material for target markets.

The present system provides for translating outside databases (e.g. crime reports, public transit) into a normalized format for manipulation and handling of data. These databases are defined as “3^{rd} Party Databases”. The translation process is done to maintain consistency across the platform. The data is translated as follows: 3^{rd} Party Databases are used to weight the route based on location, time, date, and severity. In order to accomplish this, the data is redefined as points with location, types, subtypes, date, and various other data-specific details. A unique objectID (assigned by the database) is then used to distinguish and call the various data. A credibility variable is also used to distinguish on the quality of the data received from the 3rd party database so as to not affect the integrity of the route scoring algorithm. For example, a 3^{rd} Party Database that shows the density of pigeons in a certain area would be of less weight than a 3^{rd} Party Database that shows violent crime occurrences.

In an exemplary embodiment, a “CityUpdate” function runs daily to store a text string of the city name associated with a latitude and longitude. This updates a “city” variable. This allows the app to simply pull a text string as opposed to calculating a city name each time that point is loaded. If a “city” does not exist, then the “location” is used to call a mapping program, such as Google Maps, to calculate the city.

As a further embodiment, a “Spam” function can be run every 30 minutes to look for a high Spam count that changes based on the user count in the area. The function also looks for relatively new points that have received Spam ratings from users to eliminate the need for a critical mass in low user regions. For example, if 10% or greater of users interacting with a point mark it as spam, the point will be automatically removed and checked for review. If 5% to 10%, the point will be submitted for review, but not immediately struck from the database.

When scrolling through various reports within the app, stories are sorted in two different ways. If a user clicks the “New Stories” button to initiate the read report view, the user will only be presented with new stories. These stories will be ordered in distance from the user's current location when they first started reading reports. If their location is currently unavailable, the function will use their last known location. If a user clicks on a particular location or a point on a map to initiate the read report view, the stories can be sorted in order by distance from that initial point. Both new and read stories can be displayed.

By cataloguing and categorizing users' interactions with data points and directions, the system is able to glean specific insights on a user's experience within and perception of a city (via measures such as walking paths, perceived safety, density of foot traffic). The system can then segment that data in ways that benefit companies, cities, and community organizations. This data becomes more valuable as additional datasets are layered to the maps and directions algorithm.

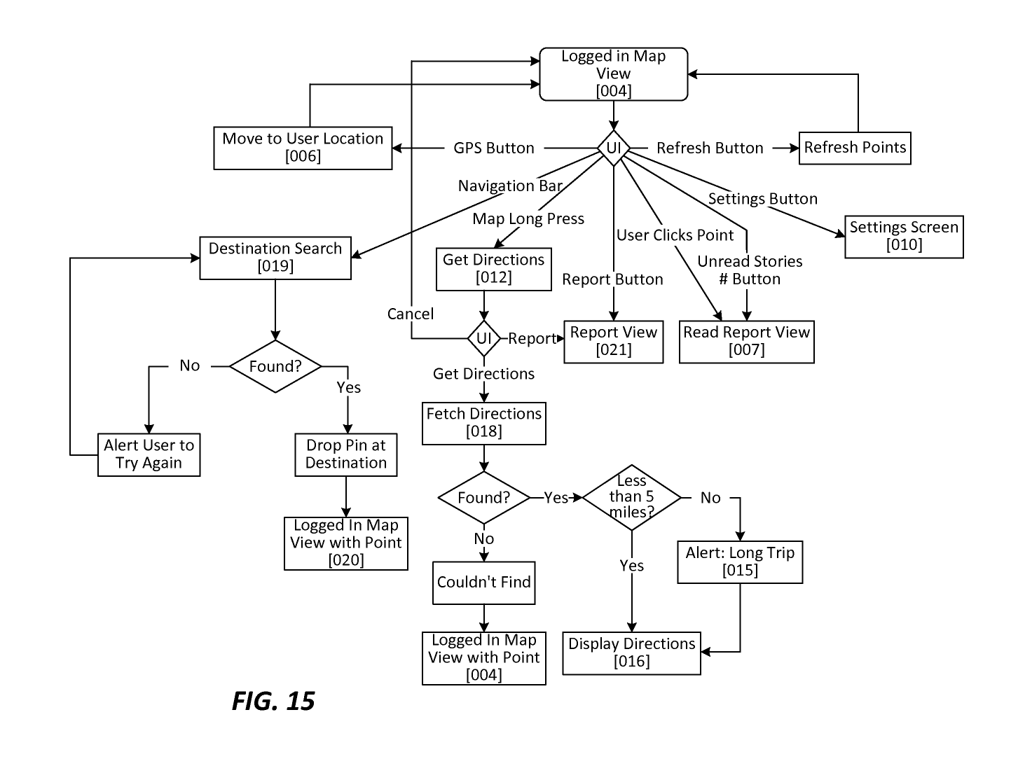

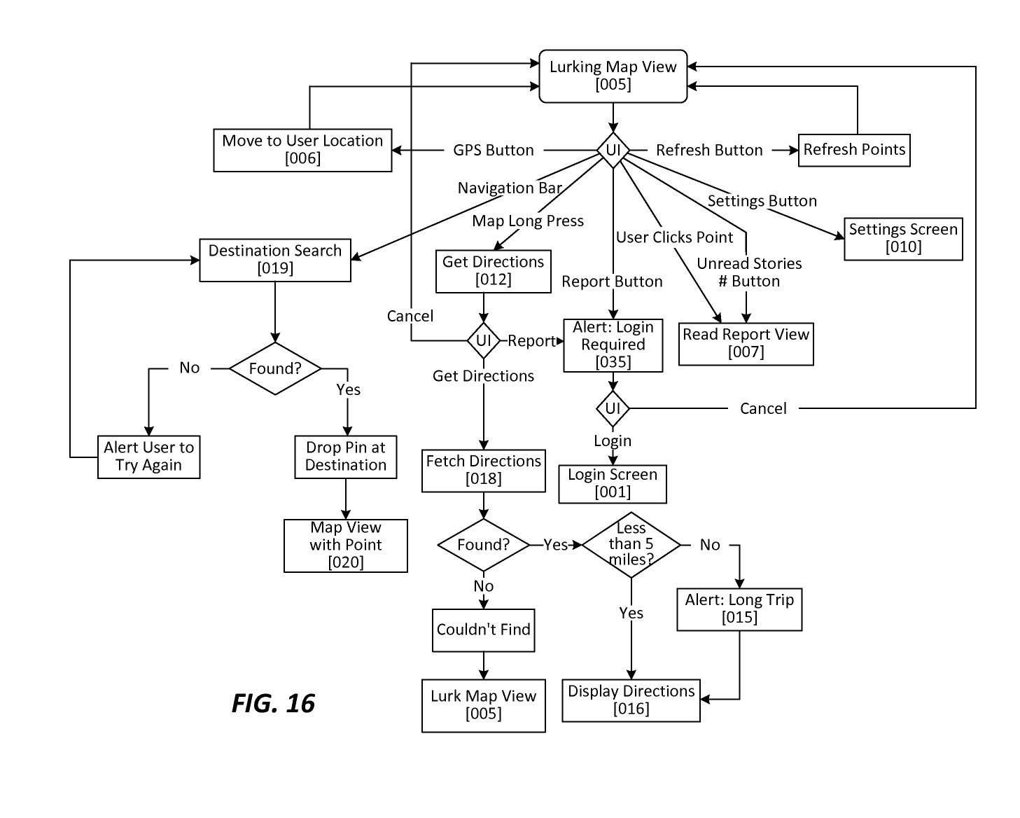

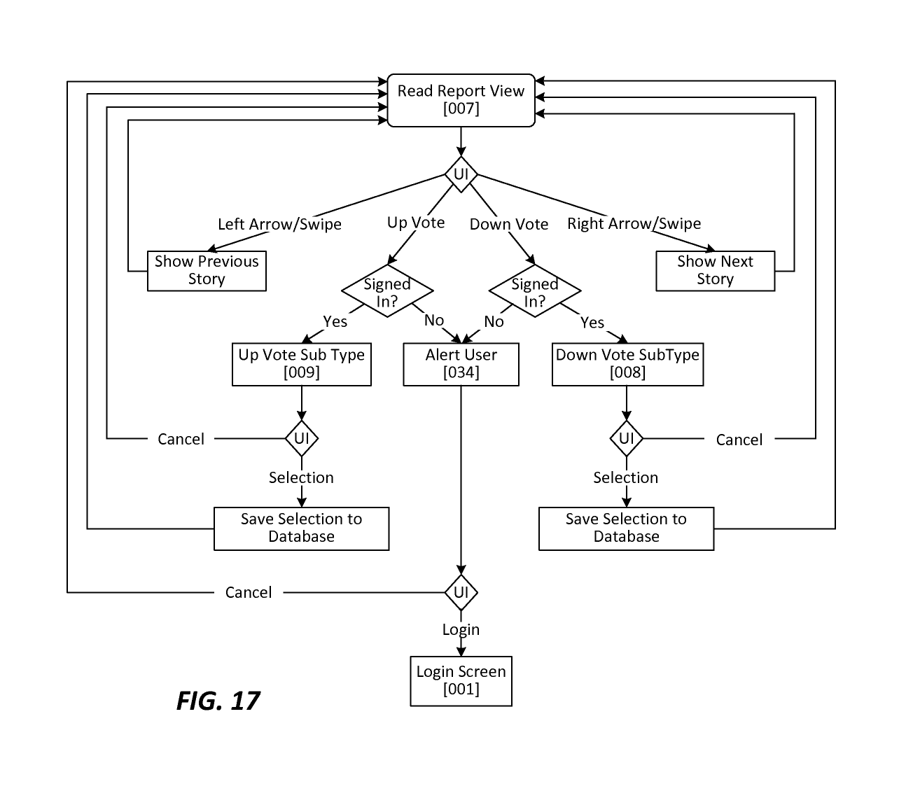

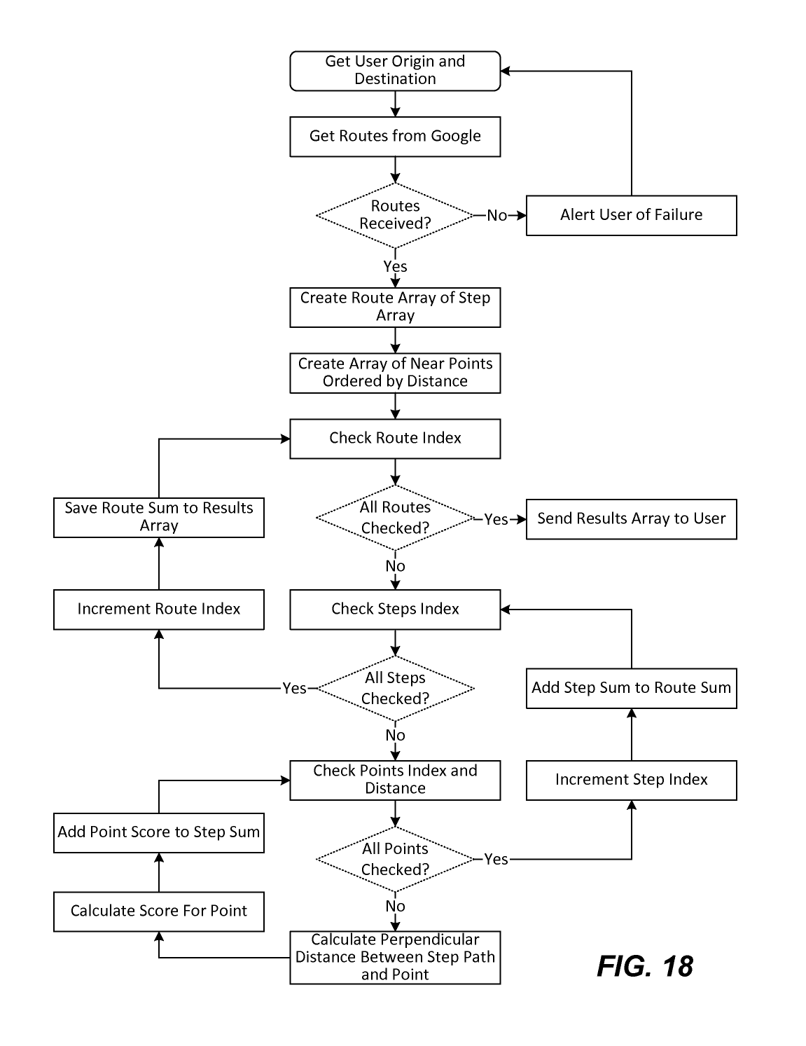

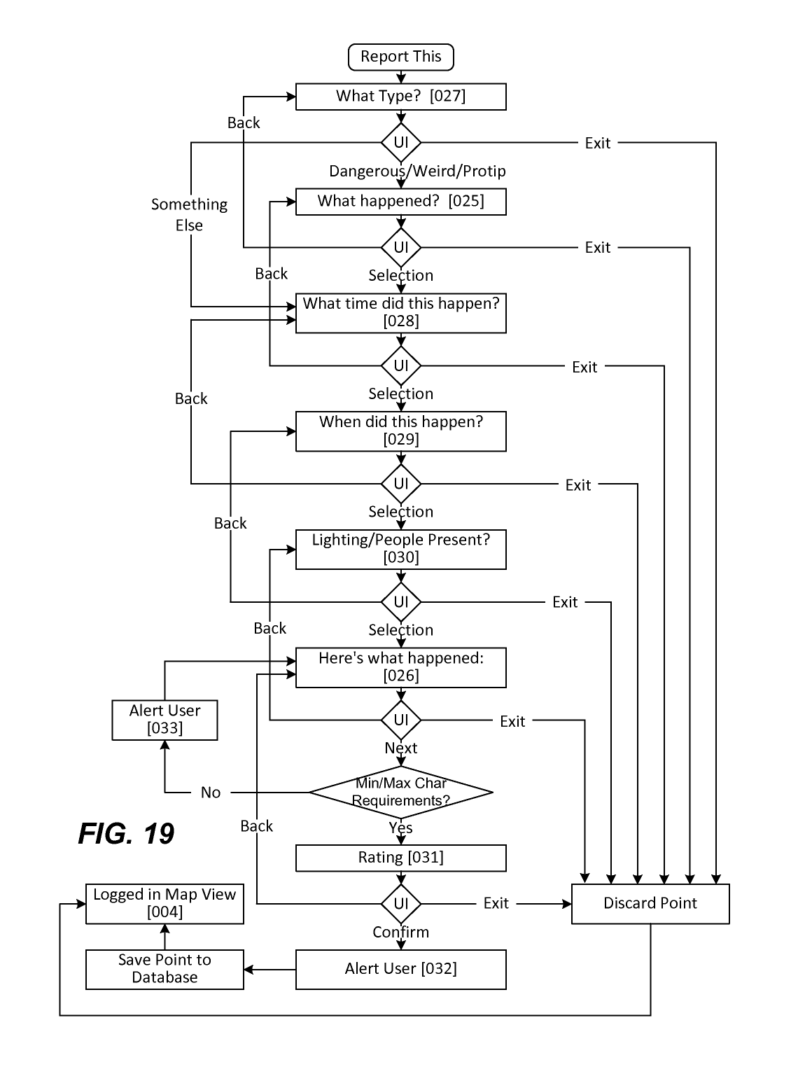

FIGS. 15-19 illustrate flow-diagrams of a process by which a user logs in to the system and provides or receives navigation-related data in accordance with embodiments of the disclosure. The following list provides a description of steps in the flow-diagrams, referred with a common element number:

(1) User Login/Lurk: A user may choose to login with an email address or enter the app anonymously with limited functionality such as reporting.

(2) User Sign Up: User must provide first name, last name, email, password, and age. This information is stored on a secure server. A verification email is also sent after sign up.

(3) User Login: A User who has previously signed up may simply log back in.

(4) Logged In Map View: Fully functional interactive map for selecting points of reports or interest only available after a user has signed up and logged in.

(5) Lurking Map View: The appearance of the “Lurking Map View” and “Logged In Map View” (4) may be the same. However, if a user is simply Lurking, they will not be able to vote on reports, report an incident, or save the points they have interacted with as read. Anytime they attempt one of these actions, they will be prompted to either log in or cancel their request to complete the action. Lurkers can still, however, read reports and get directions. However, directions will not be catered to their specifications as there is no user interaction history.

(6) Map View with User Location: User's location displayed on the map with ability to click several options such as directions, reading reports, destination searching.

(7) Read Report View: For reading reports. Information including time of day, time from incidence, lighting conditions of the area, level of severity, and text indicating what happened.

(8) Downvote Screen: Options for choosing reasons for downvoting the report.

(9) Upvote Screen: Options for choosing reasons for upvoting the report.

(10) Settings Screen Account Options: User may sign out, view a tutorial, view the Terms of Service, or Contact Us.

(11) Settings Screen Point Options: Users may select which points to view as well as view a legend for “disreputability” rating.

(12) Long Press Alert: Users may cancel, report disreputability, or get directions.

(13) Destination Search: Users may search for a destination using the Google Places search engine embedded in the app.

(14) Destination Not Found: Users will be alerted if a destination could not be found.

(15) Long Walk Alert: Users are notified if a desired walk is over 5 miles in total distance.

(16) Navigation Route View: Three routes are presented to the user in corresponding disreputability levels coloring ranging from 0-10 where 0-3=green, 4-6=yellow, and 7-10=red.

(17) Navigation Search: Users may modify their beginning location and ending location for navigation.

(18) Navigation Search with Suggestions: Navigation will offer suggestions based on the user's current location.

(19) Point of Interest Search: Users may search for a specific point of interest. The app will make suggestions based on the user's search and current location.

(20) Map View with Point of Interest: After searching, the user will see their point of interest designated by a blue pin.

(21) Report View: Users may choose the location of the incident by moving the map and interacting with both a satellite view and traditional map.

(22) Contact Us: A prepopulated form in the users default email client with our contact address as well as some sample information.

(23) Terms of Conditions: A scrollable display of the terms of service that are displayable by any user at any time.

(24) Tutorials: A set of images that teach a user the basic functions of the app.

(25) Subtype Screen: Titled as “what happened?”. Allows the users to select a sub category of the reported incident.

(26) Open Ended Report: Users may type up to 500 characters regarding the incident they experienced.

(27) Main Type Screen: Users may select for several options to provide a main category for the incident.

(28) Time Selection: Users may select the time of day that the incident occurred.

(29) When Selection: Users may select how long ago that the incident occurred.

(30) Lighting/People Present: Users may select both lighting and number of others present.

(31) Rating: Users may slide the icon on the page to rank the report from 1-5.

(32) Thanks Screen: Thank you splash screen while point is uploading to database.

(33) Min Char Alert: Screen to alert user they must enter text details of the location to continue.

(34) Lurk Alert: Screen to alert user they must login to complete the action.

(35) Alert: Login Required: Screen to alert user they must login to complete the action.

(36) Mobile Device: A mobile device with GPS and/or internet connectivity.

(37) GPS: Device for communicating a user's latitude and longitude.

(38) Database: A cloud database for storing information and calculating user requests.

The term “embodiments,” phrases such as “in one embodiment,” and the like, generally mean the particular feature(s), structure(s), method(s), or characteristic(s) following or preceding the term or phrase is included in at least one embodiment of the present invention, and may be included in more than one embodiment of the present invention. In addition, such terms or phrases do not necessarily refer to the same embodiments.

The above Detailed Description of examples of the embodiments is not intended to be exhaustive or to limit the embodiments to the precise form disclosed above. While specific examples for the embodiments are described above for illustrative purposes, various equivalent modifications are possible within the scope of the embodiments, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

Any patents and applications and other references noted above, including any that may be listed in accompanying filing papers, are incorporated herein by reference. Aspects of the embodiments can be modified, if necessary, to employ the systems, functions, and concepts included in such references to provide further implementations of the embodiments.

Various modifications and additions can be made to the embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations and all equivalents thereof.

1. A method comprising:
receiving a route request via a mobile device of a user, the route request for a route between a starting location and an ending location;
determining an initial landmark array based, at least in part, on an initial segment of the route, the initial landmark array including one or more landmarks located along the initial segment of the route;
providing navigational information to the user, the navigational information including the initial landmark array for the initial segment of the route; and
until the user reaches the ending location:
dynamically updating the navigational information based, at least in part, on information relating to movement of the user with respect to the ending location; and
providing the updated navigational information in real-time to the user.

2. The method of claim 1, further comprising:
calculating a polyline route based, at least in part, on the starting location and the ending location, the polyline including the initial segment of the route.

3. The method of claim 1, further comprising:
calculating a polyline route based, at least in part, on the starting location and the ending location, wherein a heading direction is calculated based, at least in part, on the segment of the polyline route and a current location of the user.

4. The method of claim 1, wherein the navigational information includes a photograph of the one or more landmarks.

5. The method of claim 1, wherein the navigational information includes a photograph of the additional landmarks located along one or more of the remaining segments of the route.

6. The method of claim 1, wherein updating the navigational information includes updating the initial landmark array with additional landmarks located along one or more of the remaining segments of the route.

7. The method of claim 6, wherein updating the navigational information includes updating, with respect to a landmark in the additional landmarks, a heading direction calculated based, at least in part, on a segment of the polyline route and a current location of the user and the orientation.

8. The method of claim 1, the determining further comprising:
querying a landmark database for landmark data; and
sorting the landmark data according to a set of landmark visibility criteria to generate the initial landmark array.

9. The method of claim 8, wherein the landmark visibility criteria is selected from the list: a type of a landmark, a footprint based on a number of businesses operating close to the landmark, a size of the landmark, operating hours of the landmark, peak hours of operation, an angle of incidence of the landmark's location with respect to a user's location, sensory cues associated with the landmark, a credibility factor representing likelihood that the landmark exists, user ratings of the landmark, and a date-relevance factor indicating how relevant the landmark is on certain dates.

10. The method of claim 1, further comprising:
modifying the navigational information of the user based on information received from other sources.

11. The method of claim 10, wherein the other sources includes a second user, the second user different from the first user.

12. The method of claim 11, wherein the information is a photograph taken by the second user.

13. The method of claim 10, wherein the other sources includes a third party geographic database.

14. The method of claim 1, wherein a landmark in the one or more landmarks comprises at least one of: a visual, a haptic, an auditory, or a sensory-recognized element.

15. A computer program product comprising a non-transitory, computer-readable medium having instructions stored thereon, the instructions comprising code for:
decomposing a polyline route derived from a route request received from a user, the route request related to a route between a starting location and an ending location, the polyline route including a collection of segments, each segment of the polyline route based, at least in part, on a latitude and a longitude pair;
determining a landmark array, based on the route request, the landmark array including one or more landmarks located along each segment of the polyline route; and
providing navigational information to the user, the navigational information including the landmark array for each segment of the route, the landmark array generated, for each segment of the polyline route and, at least from, the latitude and the longitude pair in conjunction with visibility criteria representative of a quality of the one or more landmarks in the landmark array.

16. The computer program product of claim 15, the determining further comprising:
querying a landmark database for landmark data; and
sorting the landmark data according to a set of landmark visibility criteria to generate the landmark array.

17. The computer program product of claim 16, wherein the landmark visibility criteria is selected from the list: a type of a landmark, a footprint based on a number of businesses operating close to the landmark, a size of the landmark, operating hours of the landmark, peak hours of operation, an angle of incidence of the landmark's location with respect to a user's location, sensory cues associated with the landmark, a credibility factor representing likelihood that the landmark exists, user ratings of the landmark, and a date-relevance factor indicating how relevant the landmark is on certain dates.

18. An apparatus comprising:
computer memory for storing landmark-related data from a plurality of sources, the landmark-related data including visibility criteria pertinent to identification of landmarks along a user's route; and
a processor for:
receiving a route request via a mobile device of a user, the route request for a route between a starting location and an ending location;
determining an initial set of navigation directions, based, at least in part, on an initial part of the route, the initial set of navigation directions including one or more landmarks located along the initial segment of the route, a heading direction;
providing navigational information to the user, the navigational information including the initial landmark array for the initial segment of the route, the ; and
until the user reaches the ending location:
dynamically updating the navigational information, including the initial landmark array, based, at least in part, on information relating to movement of the user with respect to the ending location and the visibility criteria ; and
providing the updated navigational information in real-time to the user.

19. The apparatus of claim 18, wherein a landmark in the one or more landmarks comprises at least one of: a visual, a haptic, an auditory, or a sensory-recognized element.

20. The apparatus of claim 18, wherein the starting location is determined automatically via a location-sensing mechanism associated with the mobile device of the user.
